(19) United States
(12) Patent Application Publication
(10) Pub. No.: US 2013/0194646 A1
(43) Pub. Date: Aug. 1, 2013

(54) OPTICAL CONVEYORS

(71) Applicant: New York University, New York, NY (US)

(72) Inventors: David B. Ruffner, New York, NY (US); David G. Grier, New York, NY (US)

(73) Assignee: New York University, New York, NY (US)

(21) Appl. No.: 13/753,298

(22) Filed: Jan. 29, 2013

Related U.S. Application Data
(60) Provisional application No. 61/593,128, filed on Jan. 31, 2012.

(51) Int. Cl. G03H 1/04

(52) U.S. Cl. CPC G03H 1/04
USPC 359/28

(57) ABSTRACT

Optical conveyors providing motive force to objects. The optical conveyors are one-sided and are able to exert forces on illuminated objects that are directed opposite to the direction of the light's propagation.

### CROSS REFERENCE TO RELATED APPLICATION

This application claims priority from U.S. Provisional Patent Applications 61/593,128 filed Jan. 31, 2012 and is herein incorporated, by reference in its entirety.

### STATEMENT OF GOVERNMENT INTEREST

The United States Government has certain rights in this invention pursuant to National Institute of Health Contract Nos. DMR-0855741 and DMR-0922680.

### BACKGROUND OF THE INVENTION

Transportation of materials by a traveling wave has been investigated previously. Generally, the term “tractor beam” refers to a traveling wave that has the capacity to transport material back to its source. By this definition an optical tweezer is not a tractor beam because of its inherently limited range. Nor is an optical conveyor belt a tractor beam, which Is created from, a standing wave rather than a traveling wave. The latter distinction reflects the need to establish boundary conditions for the standing wave on both sides of the transported object, thereby inherently limiting its range.

Most beams of light do not act as tractor beams because their radiation pressure tends to repel illuminated objects rather than attract them. This also is true of other types of traveling waves, such as acoustic waves. Recently, however, two categories of tractor beams have been introduced based on invariant or non-diffracting traveling waves. One relies on the recoil force that an illuminated object experiences if it redirects a beam's linear momentum into the forward-scattering direction. This property has been predicted to be possible in both acoustic and optical Bessel beams, but has not yet been demonstrated in practice. The other approach is based on solenoidal waves whose axial intensity gradients tend to counteract axial radiation pressure, and whose helical phase gradients redirect tangential radiation pressure to induce net upstream motion. This approach is more general than that based on Bessel beams because it is substantially insensitive to details of the scattering properties of the illuminated object. Solenoidal tractor beams have been successfully demonstrated in experiments on micrometer-scale colloidal spheres. However, both of these two categories of tractor beams present drawbacks that serve as a barrier for practical application.

### SUMMARY OF THE INVENTION

One embodiment of the present invention relates to a method for manipulating an object. A first beam of coherent light is generated. A second beam of coherent light is generated, the second beam, and the first beam being coaxial, having a frequency ω and polarization ê, and propagating along the \hat{z} direction. Retrograde optical force is thereby exerted for driving an object.

Another embodiment of the present invention relates to a computer-implemented machine for manipulating an object. The machine includes a processor; and a tangible computer-readable medium operatively connected to the processor and including computer code configured to control the process; generating a first beam of coherent light; generating a second beam of coherent light, the second beam and the first beam being coaxial, having a frequency ω and polarization ê, and propagating along the \hat{z} direction; and thereby exerting a retrograde optical force for driving on an object.

Another embodiment of the present invention relates to a tangible computer-readable medium including computer code configured to: generate a first beam of coherent light; and generate a second beam of coherent light, the second beam and the first beam being coaxial, having a frequency ω and polarization \hat{ε}, propagating along the \hat{z} direction; and thereby exerting a retrograde optical force for driving an object.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a volumetric reconstruction: of the three-dimensional intensity distribution of an optical conveyor projected with the holographic optical trapping technique;

FIG. 2(a) shows a schematic representation of a holographic projection of a Bessel beam with axial wavenumber αk by a lens; the shaded region indicates volume of invariant propagation; FIG. 2(b) shows a volumetric reconstruction of a holographically projected Bessel beam; FIG. 2(c) shows a phase hologram encoding an optical conveyor; diagonal blazing tilts the projected conveyor away from the optical axis, and FIG. 2(d) shows volumetric reconstruction of the beam projected by the hologram in FIG. 2(c) and the gray scale encoded bar indicates relative intensities in FIGS. 2(b) and 2(d);

FIG. 3(a) shows trajectories of two 1.5 μm diameter colloidal silica spheres moving along a pair of optical conveyors, superimposed with a holographic snapshot of the two spheres; “colored” (gray scale encoded) orbs indicate the spheres' positions in the hologram, and are plotted at the same scale as the actual spheres; rings are added for emphasis; FIG. 3(b) shows measured time dependence of the spheres' axial positions as one moves downstream (+\hat{z}) along its conveyor and the other moves upstream (−\hat{z}) and FIG. 3(c) shows three-dimensional reconstruction of a holographic snapshot of two colloidal spheres moving along a single optical conveyor; and

FIG. 4 Illustrates one form of a system for implementing an embodiment of the invention.

### DETAILED DESCRIPTION OF THE PREFERRED EMBODIMENTS

In the following detailed description, reference Is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged. substituted, combined, and designed in a wide variety of different configurations, all of which are explicitly contemplated and made part of this disclosure.

A category of tractor beams is described herein in addition to the two categories of tractor beams noted above, recoil force and solenoidal waves. The described tractor beams qualitatively resemble optical conveyor belts but can be projected from a single source, i.e. is “one-sided” as opposed to being projected from two sources from opposing sides. Like solenoidal tractor beams, the one-sided conveyor uses intensity-gradient forces to counteract radiation pressure and localize illuminated objects. Unlike solenoidal tractor beams, it relies on systematic variation of the beam's mode structure to achieve upstream motion. Consequently, in one embodiment, one-sided conveyors oiler direct control over the direction and speed of axial motion for all objects trapped anywhere along their length.

One embodiment of a one-sided optical conveyor is based on a specifically phased superposition of two coherent coaxial Bessel beams of frequency ω and polarization ê, whose vector potential may be written in cylindrical coordinates r=(r, θ, z) as

A₀(r, t)=J₀((k²−α²)^{1/2}r)e^{iαz}e^{-iωt}\hat{ε}+e^{iφ}J₀((k²−β²)^{1/2}r)e^{iβz}e^{iωt}\hat{ε}, (1)

where k=ω/c is the wavemember of light in a medium with wave speed c. The functions J₀(qr) are Bessel functions of the first kind of order 0. The two beams differ in their axial wavenumbers, α and β, which satisfy 0<α, β<k, and in their relative phase φ. Although it should be appreciated that the two terms also might be assigned different amplitudes, for one embodiment the terms are given the same amplitude as in Eq. (1), which optimizes the interference between the two beams. Optimizing the interference between the two Bessel beams optimizes the superposition's performance for micromanipulation.

The component Bessel beams have amplitude 1 along the optical axis, r=0. The conveyor's axial intensity thus is

$$\begin{matrix}I ( 0 , θ , z ) = {\vert {e}^{iα z} + {e}^{i ϕ} {e}^{i β z} \vert}^{2} ( 2 ) \\ = {cos}^{2} ( \frac{1}{2} [ ( α - β ) z - ϕ ] ) . ( 3 )\end{matrix}$$

The axial intensity thus is characterized by maxima separated by

$$Δ z = \frac{2 π}{\vert α - β \vert} \qquad ( 4 )$$

These intensity maxima act as three-dimensional traps for bright-seeking objects following the same principle for axial trapping in conventional optical tweezers. Unlike optical tweezers, which feature a single trap near the focus of a converging beam of light, the non-diffracting beam described by Eq. (1) has maxima at axial positions:

$${z}_{a} = \frac{2 π n + ϕ}{α - β} , \qquad ( 5 )$$

where the index n is an integer. Rather than a single trap of optical tweeters, each one of these intensity maxima can act as an axial trap, thus providing a series of optical traps.

In one embodiment, a tractor beam in accordance with principles of the present invention is not disrupted by interrupting the central core of the Bessel beam. If an object blocks the Bessel beam, the beam regenerates from the rings of the Bessel beam on the other side of the blocking object. Without limiting the scope of the invention, it is believed that the “self-healing” nature of this arrangement of Bessel beams allows multiple objects to be trapped along a single conveyor beam despite light scattering by each of the trapped objects.

Between each pair of maxima is an intensity minimum, which can act as a trap for a dark-seeking object. A single optical conveyor beam therefore can simultaneously trap light-seeking and dark-seeking particles.

As shown by Eq. (5), the positions of the axial traps can be displaced along the axial direction by varying the relative phase φ. Increasing φ displaces the traps along the +\hat{z} direction and transports trapped objects away from the source of the beam. Similarly, decreasing φ moves trapped objects in the −\hat{z} direction, thereby fulfilling the fundamental requirement of a tractor beam. Continuously varying φ moves trapped objects continuously along z with axial, velocity

$$v ( t ) = \frac{{\partial }_{t} ϕ ( t )}{α - β} . \qquad ( 6 )$$

In one embodiment of a one-sided optical conveyor, trapped objects will move with the same velocity regardless of their sizes, shapes, or optical properties. This differs from the action of the recoil-force Bessel-based tractor beams in which even the sign of the induced motion depends on each object's properties, and solenoidal tractor beams for which the speed will vary. Further, bidirectional motion in recoil force Bessel-based tractor beams is potentially problematic because objects moving in opposite directions can impede motion altogether. By moving all materials in the same direction at the same speed, the conveyor described by Eq. (1) avoids all such transport problems.

The values of α and β also determine the transverse widths of the axial maxima that constitute the conveyor beam. These widths help to determine the three dimensional structure of the conveyor beam, beyond its axial intensity profile. The widths therefore may be selected, to optimize such properties as the lateral sizes of the trapping regions and the lateral range over which the conveyor draws objects into its traps.

In one embodiment, one-sided conveyor beams also can be created with higher-order Bessel components. These higher-order conveyor beams tall into two categories whose vector potentials may be written as

Aₘ(r, t)=Jₘ((k²−α²)^{1/2}r)e^{iαz}e^{imθ}e^{-iωt}\hat{ε}+e^{iφ}Jₘ((k²−β²)^{1/2}r)e^{iβz}e^{imθ}e^{iωt}\hat{ε} (7)

A_{z,m}(r, t)=Jₘ((k²−α²)^{1/2}r)e^{iαz}e^{imθ}e^{-iωt}\hat{ε}+e^{iφ}Jₘ((k²−β²)^{1/2}r)e^{iβz}e^{imθ}e^{iωt}\hat{ε} (9)

Like the zeroth-order conveyor, both of these have intensity maxima at positions zₙ along \hat{z} given by Eq. (5). They differ in that their principal maxima are displaced from, r=0 by amounts that depend on m, α, and β. This larger transverse range may be useful for conveying irregular or asymmetrically shaped objects, or objects with inhomogeneous optical properties. The two classes of higher-order conveyors differ from each other in that Aₘ(r,t) describes a beam that carries orbital angular momentum, whereas the beam described by A_{±m}(r,t) does not. One consequence of the orbital angular momentum in Aₘ(r,t) is that objects trapped in the axial direction will tend to circulate around the optical axis.

It should be appreciated that the foregoing discussion of optical conveyor beams does not account for the inertia of objects interacting with the light. This is appropriate for objects that are immersed in a viscous medium and whose motions are damped accordingly. The conveyor beams that we describe also may be useful for trapping and moving objects in inviscid media, including vacuum. The wider of the two component Bessel beams establishes a cylindrical shell of light outside the axial trapping region whose radiation pressure is directed in the +\hat{z} direction. This therefore counteracts motion in the −\hat{z} direction that might be induced by the conveyor's operation. It will slow particles: that are being propelled out of the conveyor, and thus tend to retain them within the beam. This is a form of optical drag that will help to maintain conveyor action even in media that do not provide inherent drag.

The Bessel beams discussed herein can be created in a number of ways, for example with the holographic trapping technique, or alternatively by creating two Bessel beams with free-space optics and combining them with a beam splitter. Other approaches are believed to include establishing a laser cavity that resonates naturally in a conveyor mode.

It should be further appreciated that the manner of changing the phase may impact the motion of the optical traps. For example, the object moves stepwise if the phase is changed in a stepwise manner, and continuously if the phase is changed in a continuous manner. Holographically projected conveyors would have step-wise motion. Conveyors projected with free-space optics might advance continuously as the optics are continuously moved.

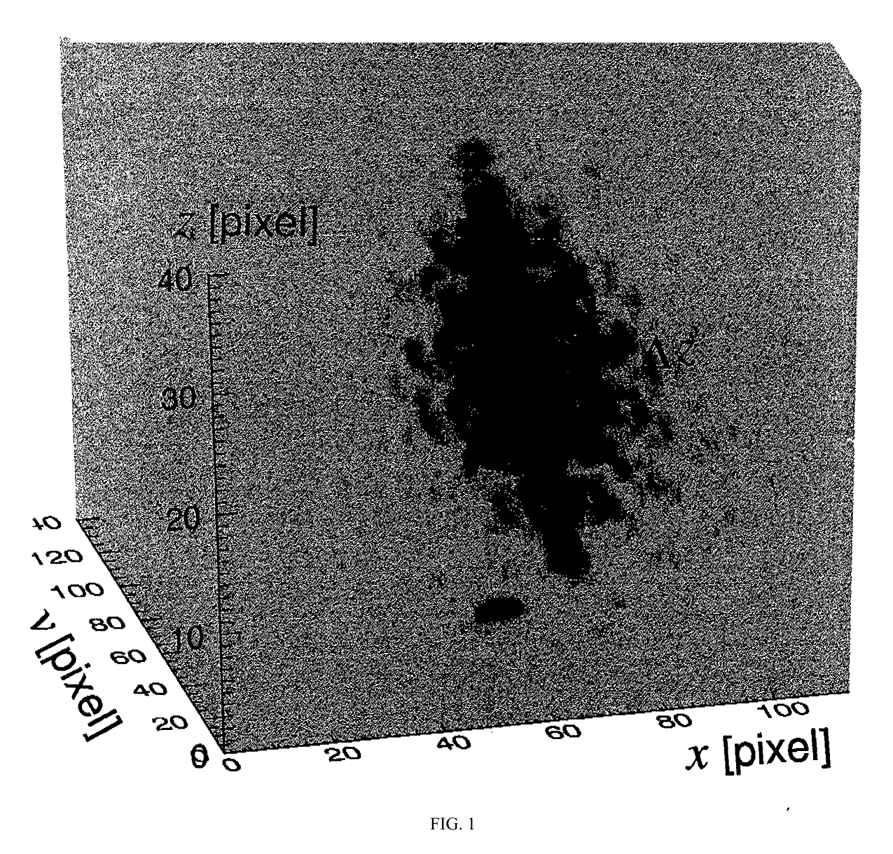

FIG. 1 is a volumetric reconstruction of the three-dimensional intensity distribution of an optical conveyor projected with the holographic optical trapping technique. The reconstruction features an array of intensity maxima separated by a distance Δz as described in the narrative. This optical conveyor is inclined with respect to the experimental axes, so that the optical z axis is tilted with respect to the plotted z axis. Distances are measured in experimental pixels, each of which measures 135 nm.

Further examples of optical conveyors were constructed using the holographic optical trapping technique in which a computer-designed phase profile is imprinted onto the wavefronts of a Gaussian beam, which then is projected into the sample with a high-numerical-aperture objective lens of focal length f. In practice, the trap-forming hologram is implemented with a computer-addressable spatial light modulator (SLM) (Hamamatsu X8267-16) that imposes a selected phase shift at each pixel in a 768×768 array. In one embodiment, Eq. (8) takes the following form

$${A}_{m} ( r , t ) = {A}_{m} [ {J}_{m} ( {[ 1 - {α}^{2} ]}^{\frac{1}{2}} kr ) {e}^{iα kz} + {ηe}^{iφ ( t )} {J}_{m} ( {[ 1 - {β}^{2} ]}^{\frac{1}{2}} kr ) {e}^{i β kz} ] {e}^{i m Θ} {e}^{- i ω t} \hat{ɛ} , \qquad ( 9 )$$

where k=nₘω/c is the wavenumber of light in a medium with refractive index nₘ, and Jₘ(*) is a Bessel function of the first kind of order m. The two beams differ in their axial wavenumbers, αk and βk, which are reduced from k by factors α and β, each of which is greater than 0 and less than 1. They also differ in their relative phase φ(t), whose time variation makes the conveyor work. The prefactor Aₘ is the beam's amplitude. Setting the relative amplitude to unity, η=1, maximizes the conveyor's axial intensity gradients and thus optimises its performance for optical manipulation. If the field described by Eq. (9) is to be projected into the objective's focal plane, the field in the plane of the hologram is given in the scalar diffraction approximation by its Fourier transform,

$${\tilde{A}}_{m} ( r , t ) = {i}^{m + 1} \frac{f}{k} {A}_{m} {e}^{i m Θ} {e}^{- i ω t} \times [ \frac{1}{r α} δ ( r - {r}_{α} ) + {ηe}^{iϕ ( t )} \frac{1}{r β} δ ( r - {r}_{β} ) ] \hat{ɛ} , \qquad ( 10 )$$

where δ(·) is the Dirac delta function.

$${r}_{α} = {f ( 1 - {α}^{2} )}^{\frac{1}{2}} and {r}_{β} = {f ( 1 - {β}^{2} )}^{\frac{1}{2}} ,$$

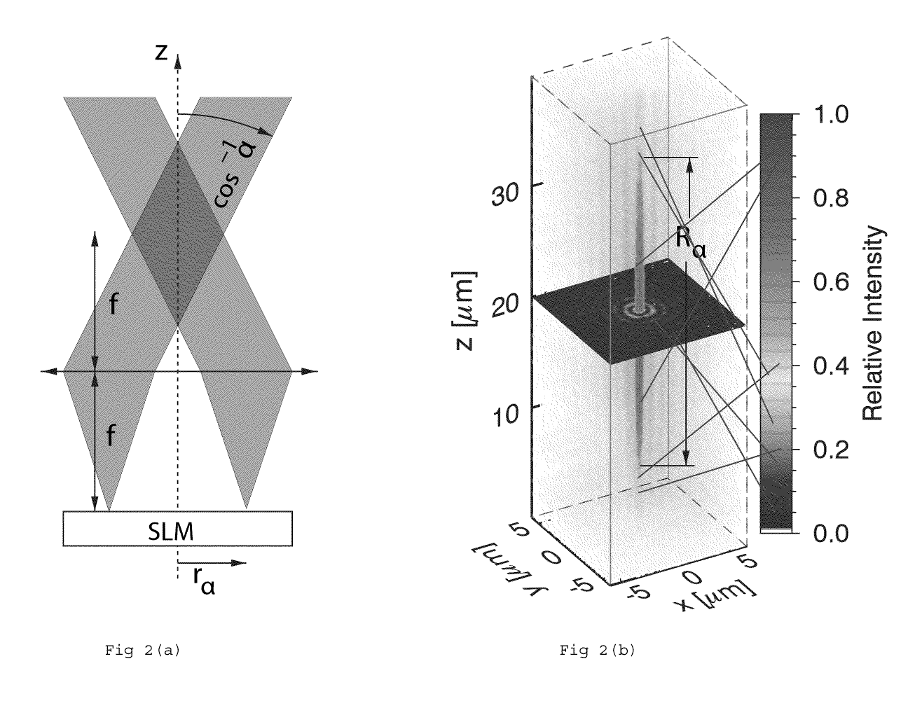

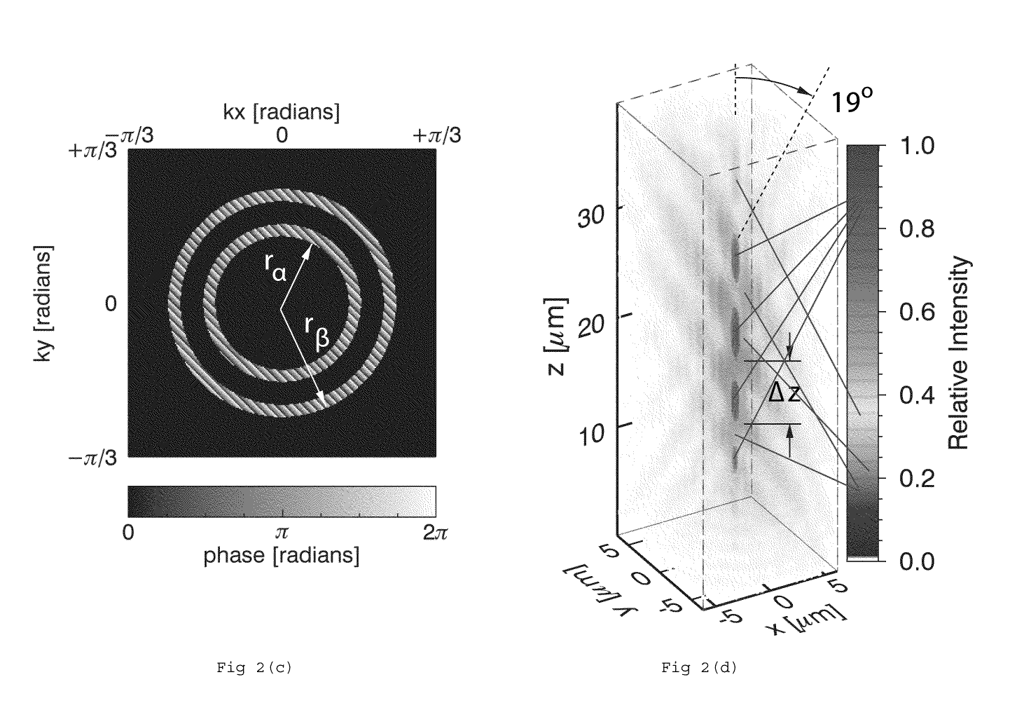

The ideal hologram for each Bessel beam comprising the conveyor thus is a thin ring in the plane of the SLM, as indicated schematically in FIG. 2(a). A holographically projected Bessel beam then propagates without diffraction over the range indicated by the shaded region. Increasing the transverse wave number increases the radius of the hologram and therefore reduces the non-diffracting range.

FIG. 2(b) shows a volumetric reconstruction of a Bessel beam projected with a ring-like hologram. Increasing the ring's thickness of the ring by ±Δr increases diffraction efficiency, but is equivalent to superposing Bessel beams with a range of axial wavenumbers, Δα=r_{α}Δr_{α}/αf². This superposition, contributes an overall axial envelope to the projected Bessel beam, limiting its axial range to R_{α}=2π/Δα. The axial range in FIG. 2(b) is consistent with this estimate and so is smaller than the ray-optics estimate suggested by the overlap volume in FIG. 2(a).

FIG. 2(c) shows the two-ringed phase-only hologram that encodes an optical conveyor with an overall cone angle of cos⁻¹([α+β]/2)=19°. This function corresponds to the phase of the beam's sector potential, which the SLM imprints on an incident Gaussian plane wave. The relative phase offset between the two rings determines φ(t). The relative widths of the two phase rings can be used to establish the components' relative amplitudes through

$$η = r \frac{2}{β} Δ {r}_{β} / ( r \frac{2}{α} Δ r α ) ,$$

the range of the projected conveyor then being the smaller of R_{α} and R_{β}.

The large featureless regions in FIG. 2(c) do not contribute to the desired optical conveyor. Light passing through these regions is not diffracted and therefore converges at the focal point of the optical train. To prevent interference between the diffracted and undiffracted beams, the two phase rings contributing to the conveyor are offset and blazed with a linear phase gradient to displace the projected Bessel beams by 24 μm from the optical axis.

The volumetric reconstruction in FIG. 2(d) shows the three-dimensional intensity distribution projected by the hologram in FIG. 2(e), with \hat{z} oriented along the diffracted beam's direction of propagation. This beam dearly displays the pattern of periodically alternating bright and dark regions predicted by Eqs. (9) through (12).

The unused regions of the hologram need not go to waste. They can be used to project additional independent conveyors, much as has been demonstrated for spatially multiplexed optical traps of other types. An appropriately designed array of conveyors therefore can make full use of the light falling on the SLM and thus can be projected with very high diffraction efficiency. Each conveyor, moreover, can be operated independently of the others by selectively offsetting the phase inappropriate regions of the multiplexed hologram.

The data in FIGS. 2(b) and 2(d) were obtained with two separate optical conveyors projected simultaneously with equal intensity and equal axial period by a single hologram. The conveyors' phases were ramped at the same rate, but with opposite sign. This single structured beam of light therefore should transport material in opposite directions simultaneously. To demonstrate this, we projected the pair of conveyors into a sample of 1.5 μm diameter colloidal silica spheres dispersed in water (Polysciences, Lot #600424). The sample is contained in the 100 urn deep gap between a clean glass microscope slide and a cover-slip that was formed by and sealed with UV-curing optical adhesive (Norland 68). The slide was mounted on the stage of a Nikon TE-2000U optical microscope outfitted with a custom-built holographic optical trapping system operating at a vacuum wavelength of λ₀=532 nm. An estimated 17 mW of light were projected into each conveyer with a 100× numerical aperture 1.4 oil-immersion objective lens (Nikon Flan-Apo DIC H) at an overall efficiency of 0.5 percent.

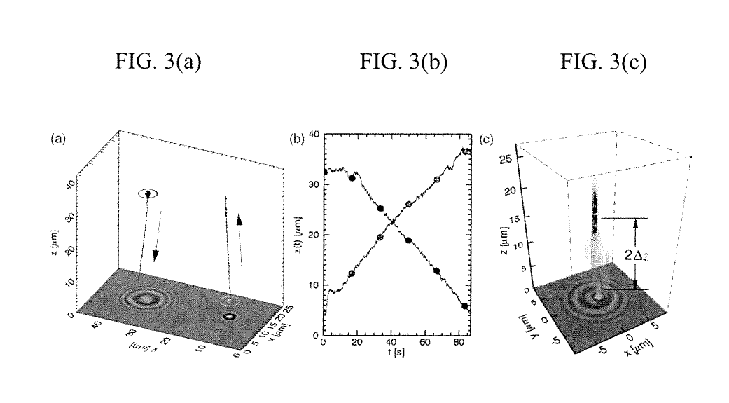

To facilitate tracking the spheres as they move along the optical axis, the microscope's conventional illuminator was replaced with a 10 mW 3 mm-diameter collimated laser beam at a vacuum wavelength of 445 nm. Interference between light scattered by the spheres and the rest of the illumination forms a hologram of the spheres in the focal plane of the objective lens that is magnified and recorded at 30 frames per second with a conventional greyscale video camera (NEC TI-324A-II). A typical holographic snapshot is reproduced in FIG. 3(a). These holograms then can be analyzed to obtain the spheres' three-dimensional positions with nanometerscale resolution. The traces in FIG. 3(a) show the full trajectories of both spheres over the course of the experiment. Colored orbs indicate the measured positions of the spheres at the instant of the holographic snapshot and are scaled to represent the actual sizes of the spheres. Starting from the configuration in FIG. 3(a), the two conveyors were run through total phase ramps of ±10π rad in steps of π/4 rad, yielding the axial trajectories plotted in FIG. 3(b), Reversing the phase ramps reverses the process. These measurements confirm that arrays of optical conveyors can selectively induce bidirectional transport over their entire lengths,

The self-healing nature of Bessel beams furthermore suggests that multiple objects can be trapped and moved by & single optical conveyor despite light scattering by each, of the trapped objects. This is confirmed by FIG. 3(c), which shows a volumetric reconstruction of the light scattered by two colloidal spheres simultaneously trapped on an optical conveyor. The plotted intensity distribution was computed from the inset, hologram by Rayleigh-Sommerfeld backpropagation. Maxima representing the positions of the spheres are separated by two periods of the underlying optical conveyor.

To characterize and optimize the transport properties of optical conveyors, we model the forces they exert in the Rayleigh approximation, which is appropriate for objects smaller than the wavelength of light. Considering both induced-dipole attraction and radiation pressure, the axial component of the force is

F(z,t)=a∂_{z}I(r,t)+bI(r,t), (11)

where the coefficients a= [symbol] {α_{c}}/(rε₀c) and b=ℑ{α_{c}}(α+β)k/(4ε₀c) parameterize the light-matter interaction, tor a particle with electric polarizabibty α_{c}. Assuming a conveyor of the form described by Eq. (10) with continuously ramped phase, φ(t)=ωt, the equation of motion tor a colloidal particle with drag coefficient γ is

$$\frac{\dot{z} ( t )}{{u}_{0}} = \sqrt{1 + {ξ}^{2}} sin ( 2 π \frac{z ( t )}{Δ z} + ω t - {cot}^{- 4 ξ} ) + 1 , \qquad ( 12 )$$

where μ₀=I₀b/(2γ) is the downstream drift, speed due to radiation pressure, and where ξ=2πa/(bΔz) describes the relative axial trapping strength. Particles that are trapped by intensity gradients are translated upstream with the conveyors phase velocity. z(t)==ν₀=−Δzω/(2π). From Eq. (12), the maximum upstream transport speed is then limited by viscous drag to

$${υ}_{0} \leq {u}_{0} \sqrt{1 + {ξ}^{2}} - {u}_{0} = \frac{{I}_{0} b}{2 γ} [ {\sqrt{1 + ( \frac{2 π a}{b Δ z} )}}^{2} - 1 ] \qquad ( 13 )$$

This remarkable result suggests that an optical conveyer can act as a tractor beam for any particle with |a|≦0 provided that it is not run too fast. Both light-seeking (a>0) and dark-seeking (a<0) particles should move in the same direction with the same speed. Optical conveyors thus have the potential to out-perform optical tweezers, which cannot always achieve stable axial trapping even in the Rayleigh regime.

Equation (13) also suggests straightforward optimization strategies for optical conveyors. Brighter conveyors can run faster. Reducing the conveyor's spatial period Δz proportionately increases the maximum transport rate at the cost of reducing the maximum range.

Higher-order conveyors with m>0 also have intensity maxima at positions zⱼ given by Eq. (16) below. They differ from zero-order conveyors in that their principal maxima are displaced from r=0 to transverse radii that depend on m, α and β. This larger transverse range may be useful for conveying irregular or asymmetrically shaped objects, or objects with inhomogeneous optical properties. Higher-order conveyors also carry orbital angular momentum so that objects trapped in the axial direction will tend to circulate around the optical axis.

In the special case m=0, n=1, the component Bessel beams have unit amplitude along the optical axis, r=0, and the conveyor's axial intensity is

$$\begin{matrix}{lim}_{r \to 0} I ( r , t ) = \frac{1}{2} {cn}_{m} {ɛ}_{a} {ω}^{2} {lim}_{r \to 0} {\vert {A}_{0} ( r , t ) \vert}^{2} ( 14 ) \\ = {I}_{0} {cos}^{2} ( \frac{1}{2} [ ( α - β ) kz - ϕ ( t ) ] ) , ( 15 )\end{matrix}$$

where I₀=2A₀²cnₘε₀ω². The beam thus has intensity maxima at axial positions

$${z}_{j} ( t ) = [ j + \frac{ϕ ( t )}{2 π} ] Δ z \qquad ( 16 )$$

that are evenly spaced by multiples, Δz=λ/(α−β), of the wavelength λ≦2π/k in the medium, and thus can be indexed by the integer j.

Objects that become trapped along I(z, t), can be displaced either up or down the axis by varying the relative phase φ(t). Continuous variations translate trapped objects deterministically along \hat{z} with axial velocity,

$$υ ( t ) = Δ z \frac{{\partial }_{t} ϕ ( t )}{2 π} \qquad ( 17 )$$

regardless of their size, shape, or optical properties. This differs from the action of Bessel-based tractor beam in which even the sign of the induced motion depends on each object's properties. It differs also from the motion induced by solenoidal tractor beams, which is unidirectional but not uniformly fast.

The transport direction predicted by Eq. (12) reverses sign in the limit of large ω, in animated objects then traveling steadily downstream at the drift speed μ₀. The crossover between upstream and downstream transport is marked by a dynamical state in which the particle alternately is transported upstream and slips back downstream. The transition to this state is established by Eq. (13) in the deterministic case described by Eq. (12). It will be strongly affected by thermal fluctuations, however, and may feature anomalous velocity fluctuations. Still other dynamical states are possible if the relative phase φ(t) varies discontinuously, for example in a Brownian ratchet protocol. Even more complicated behavior may be expected for optical conveyor transport in underdamped systems for which inertia plays a role.

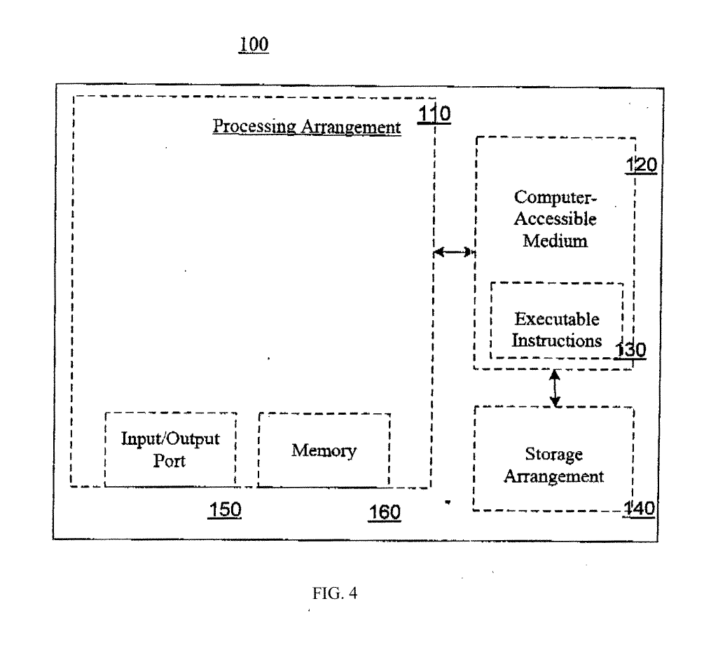

In one embodiment, shown in FIG. 4, a system 100 is provided for generating and or controlling solenoid beams as described. FIG. 4 shows an exemplary block diagram of an exemplary embodiment of a system 100 according to the present disclosure. For example, an exemplary procedure in accordance with the present disclosure can be performed by a processing arrangement 110 and/or a computing arrangement 110. Such processing/computing arrangement 110 can be, e.g., entirely or a part of or include, but not limited to, a computer/processor that can include, e.g., one or more microprocessors, and use instructions stored on a computer-accessible medium (e.g., RAM, ROM, hard drive, or other storage device).

As shown in FIG. 4, e.g., a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example.

System 100 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented, here by way of example and not limitation. Such networking environments are commonplace in office-wide or enterprise-wide computer networks, intranets and the internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted, that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations maybe expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents

What is claimed:

1. A method for manipulating an object comprising;
generating a first beam of coherent light;
generating a second beam of coherent light, the second beam and the first beam being coaxial, having a frequency ω and polarization \hat{ε}, and propagating along the \hat{z} direction; and thereby exerting a retrograde optical force for driving the object.

2. The method of claim 1, further comprising superpositioning the first beam and the second beam, the first beam and second beam differing in their relative phase φ and in their axial wavenumbers, α and β, which satisfy 0<α, β<1, where k=ω/c is the wavenumber of light in a medium with wave speed c.

3. The method of claim 2, whereto each of the first beam and second beam has a vector potential defined as, in cylindrical coordinates, r=(r, θ, z)
A₀(r, t)=J₀((k²−α²)^{1/2}r)e^{iαz}e^{-iωt}\hat{ε}+e^{iφ}J₀((k²−β²)^{1/2}r)e^{iβz}e^{iωt}\hat{ε},

4. The method of claim 3, further comprising creating a plurality of optical traps from the first and second beam.

5. The method of claim 4, wherein creating the plurality of optical traps comprises creating light optical traps and dark optical traps.

6. The method of claim 4, further comprising me step of varying the relative phase φ.

7. The method of claim 6, further comprising increasing the relative phase φ and displacing plurality of the optical traps along the +\hat{z} direction wherein the object is moved away from a source of the first beam and a source of the second beam.

8. The method of claim 6, further comprising decreasing the relative phase φ and displacing the plurality of optical traps in the −\hat{z} direction, wherein the object is moved towards a source of the first beam and a source of the second beam.

9. The method of claim 6, further comprising varying the relative phase φ wherein an object in one of the plurality of optical traps moves continuously along z with axial velocity
$$v ( t ) = \frac{{\partial }_{t} ϕ ( t )}{α - β} .$$

10. The method, of claim 6, wherein the relative phase is varied at least one of continuously and stepwise.

11. The method of claim 1 wherein a retrograde optical force is exerted on a plurality of objects, driving each of the plurality of objects at the same velocity.

12. The method of claim 1 further including the step of imposing a phase profile onto at least one of the first beam and the second beam.

13. The method as defined in claim 12 wherein at least one of the first beam and the second beam comprise a Gaussian beam.

14. The method as defined in claim 12 wherein the first beam and the second beam differ in axial wavenumber and relative phase, whereby time variations gives rise to the retrograde nature of the optical force.

15. The method as defined in claim 12 wherein the phase profile comprises a linear phase gradient, thereby displacing projections of the beams from an optical axis and preventing interference between diffracted and undiffracted beams.

16. The method as defined in claim 1 wherein the first beam and the second beam produce a hologram having periodically alternating bright and dark regions including unused portions which form additional conveyors independent of used portions of the hologram.

17. The method as defined in claim 1 wherein the first beam and the second beam produce a hologram wherein a plurality of conveyors are formed and operated independently of each of the other conveyors.

18. The method as defined in claim 1 wherein the first beam and the second beam interact to form a hologram creating two conveyors projected simultaneously with equal intensity and equal axial period but of opposite sign, thereby transporting an object of selected material in opposite directions, simultaneously.

19. A computer-implemented method for manipulating an object, comprising:
providing a processor;
connecting a tangible computer-readable medium operatively to the processor and
including a computer code configured to control manipulation of the object;
from a light source generating a first beam of coherent light; and
from a light source generating a second beam of coherent light, the second beam, and the first beam being coaxial, having a frequency ω and polarization ê, and propagating along the \hat{z} direction; and thereby exerting retrograde optical force driving on an object.

20. A tangible computer-readable medium including computer code configured to perform a method of moving an object:
from a source generating a first beam of coherent light;
from a source generating a second beam of coherent light, the second beam and the first beam being coaxial, having a frequency ω and polarization ê, and propagating along the \hat{z} direction; and
exerting from the Interaction of the first beam and the second beam a retrograde optical force driving on the object, thereby moving the object.

21. An optical system for manipulating an object comprising:
a first beam of coherent light;
a second beam of coherent light, the second beam and the first beam being coaxial, having a frequency ω and polarization \hat{ε}, and propagating along the \hat{z} direction; an interference, superpositioned output beam having an optical character for exerting a retrograde optical conveyor force for driving the object.
